(19) United States
(12) Patent Application Publication
(10) Pub. No.: US 2012/0318555 A1
(43) Pub. Date: Dec. 20, 2012

(54) POLYAMIDE-IMIDE RESIN INSULATING COATING MATERIAL, INSULATED WIRE AND COIL

(75) Inventors: Takami USHIWATA, Hitachi (JP); Yuki Honda, Hitachi (JP); Shuta Nabeshima, Hitachi (JP); Hideyuki Kikuchi, Hitachi (JP)

(73) Assignee: Hitachi Cable, Ltd., Tokyo (JP)

(21) Appl. No.: 13/526,381

(22) Filed: Jun. 18, 2012

(30) Foreign Application Priority Data
Jun. 20, 2011 (JP) 2011-136440

(51) Int. Cl. C09D 177/00; H01B 3/30

(52) U.S. Cl. 174/110 SR; 524/590

(57) ABSTRACT

A polyamide-imide resin insulating coating material includes an polyamic acid having a thermally crosslinkable reactive group, and an amide compound having a thermally crosslinkable reactive group. The polyamic acid includes an acid synthesized using at least a diamine component, a tetracarboxylic dianhydride and a cross-linking agent as raw materials. The cross-linking agent includes an amino group or an anhydride group and a thermally crosslinkable reactive group. The amide compound includes a compound synthesized using at least a carboxylic acid compound and a diisocyanate component as raw materials. The carboxylic acid compound includes a thermally crosslinkable reactive group that is crosslinkable with the cross-linking agent contained in the polyamic acid.

The present application is based on Japanese patent application No. 2011-136440 filed on Jun. 20, 2011, the entire contents of which are incorporated herein by reference.

### BACKGROUND OF THE INVENTION

1. Field of the Invention

The invention relates to a polyamide-imide resin insulating coating material, an insulated wire using the polyamide-imide resin insulating coating material, and a coil using the insulated wire.

2. Description of the Related Art

A conventional insulated wire is known which has an insulating film formed of a polyamide-imide resin insulating coating material (see, e.g., Japanese patent No. 3496636). The polyamide-imide resin insulating coating material is a heat-resistant polymer resin with substantially a half-and-half ratio of amide and imide groups and excellent in heat resistance, mechanical characteristics and hydrolysis resistance, etc.

The polyamide-imide resin insulating coating material is generally formed by a decarboxylation reaction between mainly two components, 4,4′-diphenylmethane diisocyanate (MDI) and trimellitic anhydride (TMA), in a polar solvent such as N-methyl-2-pyrrolidon (NMP), N,N-dimethylformamide (DMF), N-dimethylacetamide (DMAC) or dimethylimidazolidinone (DMI), etc.

For example, an isocyanate method and an acid chloride method, etc., are known as a method of manufacturing a polyamide-imide resin insulating coating material and the former is generally used from the viewpoint of manufacturing productivity.

In addition, there is a method in which aromatic diamine and aromatic tricarboxylic acid anhydride are reacted at 50/100 to 80/100 under acid excess condition and a polyamide-imide resin is subsequently synthesized using a diisocyanate component in order to improve characteristics of the polyamide-imide resin (see, e.g., Japanese patent No. 2897186).

Meanwhile, one of disadvantages of the polyamide-imide resin is that permittivity thereof is high and partial discharge is likely to occur when used as a material of an insulating film of an insulated wire. Since the high permittivity is caused by presence of high polar amide and imide groups contained in the polyamide-imide resin, a method is known in which a monomer having a large molecular weight is used as a raw material of the polyamide-imide resin in order to reduce the numbers of the amide and imide groups per molecular repeat unit in the polyamide-imide resin (see, e.g., JP-A-2009-161683).

### SUMMARY OF THE INVENTION

However, when the number of the high polar amide and imide in the polyamide-imide resin is modified to decrease, the solubility of the polyamide-imide resin insulating coating material may lower in a solvent, so that the solidification or precipitation of the resin is likely to occur. If the polyamide-imide resin is solidified or precipitated, the coating workability of the polyamide-imide resin insulating coating material can be significantly deteriorated.

It may be conceived as a countermeasure against the above problem to reduce the non-volatile component concentration in the polyamide-imide resin. However, when the non-volatile component concentration in the resin is reduced, it may be needed to increase the number of times of applying the coating material to obtain an insulating film having a thickness equivalent to that of a conventional art, which causes an increase in the cost. Meanwhile, in using a polyamide-imide resin having a non-volatile component concentration (not less than 20 mass %) at a level not significantly increasing the cost, the resin will be needed to be kept in an environment of a temperature of 30° C. and a humidity of 50%.for at least 30 minutes or more so as to suppress the solidification and precipitation thereof.

Accordingly, it is an object of the invention to provide a polyamide-imide resin insulating coating material that allows the formation of an insulating film excellent in partial discharge resistance and is excellent in coating workability and cost performance, as well as to provide an insulated wire using the polyamide-imide resin insulating coating material and a coil using the insulated wire.

(1) According to one embodiment of the invention, a polyamide-imide resin insulating coating material comprises:

an polyamic acid having a thermally crosslinkable reactive group; and

an amide compound having a thermally crosslinkable reactive group,

wherein the polyamic acid comprises an acid synthesized using at least a diamine component, a tetracarboxylic dianhydride and a cross-linking agent as raw materials,

wherein the cross-linking agent comprises an amino group or an anhydride group and a thermally crosslinkable reactive group,
wherein the amide compound comprises a compound synthesized using at least a carboxylic acid compound and a diisocyanate component as raw materials, and
wherein the carboxylic acid compound comprises a thermally crosslinkable reactive group that is crosslinkable with the cross-linking agent contained in the polyamic acid.

In the above embodiment (1) of the invention, the following modifications and changes can be made.

(i) The amide compound includes an imide group in a molecule thereof.

(ii) The amide compound comprises a compound synthesized using at least the carboxylic acid compound, the diisocyanate component and a trimellitic anhydride.

(iii) The amide compound has a number average molecular weight Mn of not more than 5000.

(iv) A weight ratio of the amide compound to the polyamic acid is from 99:1 to 30:70.

(v) The cross-linking agent comprises a compound having an unsaturated double or triple bond as a thermally crosslinkable reactive group.

(vi) The cross-linking agent comprises maleic anhydride.

(vii) The polyamic acid is terminated by an anhydride group.

(viii) The polyamic acid is terminated by an amino group.

(2) According to another embodiment of the invention, an insulated wire comprises:

a conductor, and

an insulating film comprising the polyamide-imide resin insulating coating material according to the above embodiment (1) and formed on the conductor or on another film on the conductor.

(3) According to another embodiment of the invention, a coil comprises:

the insulated wire according to the above embodiment (2).

### EFFECTS OF THE INVENTION

According to one embodiment of the invention, a polyamide-imide resin insulating coating material can be obtained that allows an insulating film excellent in partial discharge resistance to be formed and is excellent in coating workability and cost performance, as well as an insulated wire using the polyamide-imide resin insulating coating material and a coil using the insulated wire.

### BRIEF DESCRIPTION OF THE DRAWINGS

Next, the present invention will be explained in more detail in conjunction with appended drawings, wherein:

FIG. 1 is a cross sectional view showing an insulated wire in an embodiment of the present invention.

### DETAILED DESCRIPTION OF THE PREFERRED EMBODIMENTS

### Embodiment

It is possible to form an insulating film of an insulated wire by applying and baking a polyamide-imide resin insulating coating material in the present embodiment on a conductor made of copper, etc., or on another film on the conductor.

As the conductor of the insulated wire, it is possible to use conductors in various shapes such as round or rectangular conductor, etc. In addition, another film such as adhesive layer may be provided on or under the insulating film in order to improve adhesion, or alternatively, a self-lubricating layer or a self-welding layer may be provided on the insulating film.

Meanwhile, it is possible to form an insulating film even when the polyamide-imide resin insulating coating material is applied and baked on a member other than the conductor, such as on a film or a substrate, etc.

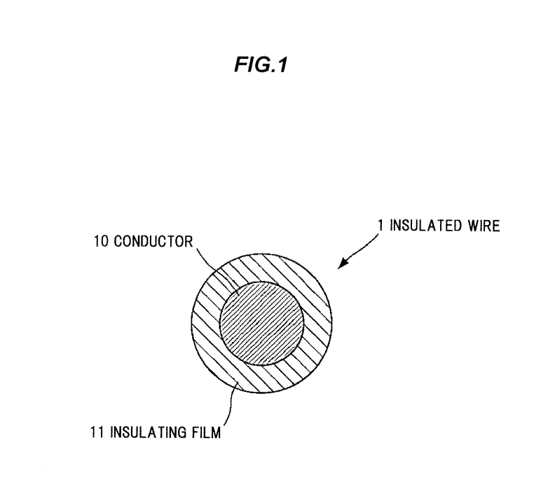

FIG. 1 shows an exemplary cross section of an insulated wire in the present embodiment. An insulated wire 1 of the present embodiment has a conductor 10 and an insulating film 11 covering the conductor 10.

Polyamide-Imide Resin Insulating Coating Material

A polyamide-imide resin insulating coating material in the embodiment contains a polyamic acid and an amide compound which each have a thermally crosslinkable reactive group. Therefore, a cross-linking reaction is caused between the thermally crosslinkable reactive group of the polyamic acid and that of the amide compound as a solvent dries due to heat treatment at the time of applying the polyamide-imide resin insulating coating material to the conductor, and a polyamide-imide resin is formed.

The polyamic acid is synthesized using at least a diamine component (A), a tetracarboxylic dianhydride (B) and a cross-linking agent (C) as raw materials. The cross-linking agent (C) has an amino group or an anhydride group and a thermally crosslinkable reactive group. Therefore, the polyamic acid has a thermally crosslinkable reactive group.

The amide compound is synthesized using at least a carboxylic acid compound (D) and a diisocyanate component (E) as raw materials. The carboxylic acid compound (D) has a thermally crosslinkable reactive group which is crosslinkable with the cross-linking agent (C) contained in the polyamic acid. Therefore, the amide compound has a thermally crosslinkable reactive group.

It is preferable that a monomer having a large molecular weight be used as a raw material to form the polyamide-imide resin insulating coating material in order to reduce the numbers of the amide and imide groups per molecular repeat unit and thereby to keep permittivity low. It is preferable that, e.g., the diamine component (A) and the diisocyanate component (E) have three or more benzene rings.

Polyamic Acid

As described above, the polyamic acid in the present embodiment is synthesized using at least the diamine component (A), the tetracarboxylic dianhydride (B) and the cross-linking agent (C) as raw materials. The cross-linking agent (C) has an amino group or an anhydride group and a thermally crosslinkable reactive group.

Also, solvents not inhibiting synthesis reaction of the polyamide-imide resin, e.g., N-methyl-2-pyrrolidon (NMP), γ-butyrolactone, N,N-dimethylacetamide (DMAC), N,N-dimethylformamide (DMF), dimethylimidazolidinone (DMI), cyclohexanone and methylcyclohexanone may be combined when synthesizing the polyamic acid.

In addition, these solvents may be used for diluting a solution. Aromatic alkyl benzenes, etc., may be used for dilution. In this regards, however, it is necessary to be cautious when there is a possibility that solubility of the polyamide-imide resin decreases.

1,4-diaminobenzene (PPD), 1,3-diaminobenzene (MPD), 4,4′-diaminodiphenylmethane (DAM), 4,4′-diaminodiphenyl ether (ODA), 3,3′-dimethyl-4,4′-diaminobiphenyl, 2,2′-dimethyl-4,4′-diaminobiphenyl (m-TB), 2,2′-bis(trifluoromethyl)-4,4′-diaminobiphenyl, 4,4′-diaminobenzophenone, 3,3′-diaminobenzophenone, 4,4′-bis(4-aminophenyl)sulfide, 4,4′-diaminodiphenyl sulfone, 4,4′-diamino benzanilide, 9,9-bis(4-aminophenyl)fluorene (FDA), 1,4-bis (4-aminophenoxy)benzene (TPE-Q), 1,3-bis(4-aminophenoxy)benzene (TPE-R), 4,4′-bis(4-aminophenoxy)biphenyl, 2,2-bis(4-aminophenoxy phenyl)propane (BAPP), bis[4-(4-aminophenoxy)phenyl]sulfone (BAPS) and 2,2-bis[4-(4-aminophenoxy)phenyl]hexafluoropropane (HFBAPP), etc., are used as the diamine component (A). In addition, hydrogenated compounds, halides or isomers, etc., of these diamine components may be used or combined.

Pyromellitic dianhydride (PMDA), 3,3′,4,4′-benzophenonetetracarboxylic dianhydride (BTDA), 3,3′,4,4′-diphenyl sulfone-tetracarboxylic dianhydride (DSDA), 4,4′-oxydiphthalic dianhydride (ODPA), 3,3′,4,4′-biphenyltetracarboxylic dianhydride, 4,4′-(2,2-hexafluoroisopropylidene)bis(phthalic anhydride) (6FDA) and 2,2-bis[4-(3,4-dicarboxyphenoxy)phenyl]propane dianhydride(BPADA), etc., are used as the tetracarboxylic dianhydride (B). In addition, butanetetracarboxylic dianhydride, 5-(2,5-dioxotetrahydro-3-furanyl-3-methyl-3-cyclohexene-1,2-dicarboxylic anhydride or alicyclic tetracarboxylic dianhydride produced by hydrogenation of the above-mentioned tetracarboxylic dianhydrides, etc. may be combined where appropriate.

Compounds having an unsaturated double or triple bond as a thermally crosslinkable reactive group, e.g., 4-(2-phenylethynyl) phthalic anhydride, 4-ethylphthalic anhydride, 4-aminostyrene, 4-ethynylaniline, 3-ethynylaniline, 4-phenylethynylaniline, 1,2,3,6-tetrahydrophthalic anhydride, maleic anhydride, methyl maleic anhydride and nadic anhydride are used as the cross-linking agent (C) having an amino group or an anhydride group and a thermally crosslinkable reactive group.

The amino group or the anhydride group contained in the cross-linking agent (C) allows the thermally crosslinkable reactive group to be introduced into the polyamic acid. In order to achieve this, the polyamic acid needs to be terminated by an anhydride group in the case of using the cross-linking agent having the amino group and by an amino group in the case of using the cross-linking agent having the anhydride group. A charge molar ratio of the diamine component (A) to the tetracarboxylic dianhydride (B) at the time of synthesizing the polyamic acid is not 1 but is adjusted so that the component desired to be a terminal is slightly excessive and it is thereby possible to select to have and anhydride group or an amino group at a terminal. An excess percentage is controlled according to the target molecular weight of the polyamic acid, characteristics of the coating material or characteristics of the film.

Amide Compound

As described above, the amide compound of the present embodiment is synthesized using at least the carboxylic acid compound (D) and the diisocyanate component (E) as raw materials. The carboxylic acid compound (D) has a thermally crosslinkable reactive group which is crosslinkable with the cross-linking agent (C) contained in the polyamic acid.

When, for example, only the carboxylic acid compound (D) and the diisocyanate component (E) are used as raw materials of the amide compound and are synthesized at a molar ratio of approximately 2:1, the amide compound having two thermally crosslinkable reactive groups and two amide bonds is produced.

An amide backbone is introduced into an insulating film of an insulated wire formed of the polyamide-imide resin insulating coating material by using the amide compound as a raw material of the polyamide-imide resin insulating coating material.

When the thermally crosslinkable reactive group of the cross-linking agent (C) has, e.g., a double or triple bond, the thermally crosslinkable reactive group of the carboxylic acid compound (D) has a double or triple bond. Decarboxylation reaction between the carboxylic acid compound (D) having a double or triple bond and the diisocyanate component (E) produces an amide bond, hence, an amide compound having a double or triple bond is obtained.

As the carboxylic acid compound (D), it is possible to use a carboxylic acid compound which is obtained by imide dehydration reaction of 4-vinylbenzoic acid or isomers thereof, 4-aminostyrene, or 4-ethynylaniline or isomers thereof with trimellitic anhydride at a molar ratio of 1:1. In addition, it is possible to use a carboxylic acid compound which is obtained by imide dehydration reaction of a compound having an anhydride group and thermally crosslinkable reactive group such as 4-(2-phenylethynyl) phthalic anhydride, 4-ethynylphthalic anhydride, 1,2,3,6-tetrahydrophthalic anhydride or nadic anhydride with 4-aminobenzoic acid or isomers thereof at a molar ratio of 1:1. However, it is not limited thereto since the carboxylic acid compound (D) may have various types of substituent groups at the cross-linked terminal and backbones between the thermally crosslinkable reactive group and a carboxylic acid.

When synthesizing the carboxylic acid compound (D) using a compound having a thermally crosslinkable reactive group and an amino group (e.g., 4-aminostyrene), this compound and a compound having a carboxylic acid and an anhydride group (e.g., trimellitic anhydride) are imidized in a solvent by thermal dehydration at about 140 to 200° C.

When synthesizing the carboxylic acid compound (D) using a compound having a thermally crosslinkable reactive group and an anhydride group (e.g., 4-ethynylphthalic anhydride) as a raw material, this compound and a compound having a carboxylic acid and an amino group (e.g., 4-aminobenzoic acid) are imidized in a solvent by thermal dehydration at about 140 to 200° C.

Solvents not inhibiting synthesis reaction of the polyamide-imide resin, e.g., N-methyl-2-pyrrolidon (NMP), γ-butyrolactone, N,N-dimethylacetamide (DMAC), N,N-dimethylformamide (DMF), dimethylimidazolidinone (DMI), cyclohexanone and methylcyclohexanone may be combined when synthesizing the carboxylic acid compound (D). In addition, these solvents may be used for diluting a solution. It should be noted that the above-mentioned method of synthesizing the carboxylic acid compound (D) is only an example and it is not limited thereto.

4,4′-diphenylmethane diisocyanate (MDI) and versatile aromatic diisocyanates such as tolylene diisocyanate (TDI), naphthalene diisocyanate, xylylene diisocyanate, biphenyl diisocyanate, diphenylsulfone diisocyanate and diphenylether diisocyanate, or isomers or multimeric complexes thereof are used as the diisocyanate component (E). In addition, aliphatic diisocyanates such as hexamethylene diisocyanate, isophorone diisocyanate, dicyclohexylmethane diisocyanate and xylylene diisocyanate, or alicyclic diisocyanates produced by hydrogenation of the above-mentioned aromatic diisocyanates, and isomers thereof may be used or combined where appropriate.

In addition, for example, 2,2-bis[4-(4-isocyanatephenoxy)phenyl]propane (BIPP), bis[4-(4-isocyanate phenoxy)phenyl]sulfone (BIPS), bis[4-(4-isocyanate phenoxy)phenyl]ether (BIPE), fluorene diisocyanate (FDI), 4,4′-bis(4-isocyanate phenoxy)biphenyl and 1,4-bis(4-isocyanate phenoxy)benzene or isomers thereof are used as the diisocyanate component (E). Although a manufacturing method thereof is not specifically limited, a method using phosgene is industrially most suitable and desirable.

A alicyclic material may be combined if necessary in order to lower permittivity and to improve transparency of the resin composition, however, since it may decrease heat resistance, blending quantity and chemical structure thereof should be carefully taken into consideration.

One of methods of synthesizing an amide compound having a thermally crosslinkable reactive group from the carboxylic acid compound (D) and the diisocyanate component (E) is to heat the carboxylic acid compound (D) and the diisocyanate component (E) in a solvent to about 60 to 140° C. while stirring. A carboxylic acid in the carboxylic acid compound (D) and an isocyanate group in the diisocyanate component (E) cause decarboxylation reaction, thereby forming an amide bond.

Also, solvents not inhibiting synthesis reaction of the polyamide-imide resin, e.g., N-methyl-2-pyrrolidon (NMP). γ-butyrolactone, N,N-dimethylacetamide (DMAC), N,N-dimethylformamide (DMF), dimethylimidazolidinone (DMI), cyclohexanone and methylcyclohexanone may be combined when synthesizing the amide compound. In addition, these solvents may be used for diluting a solution.

In addition, it is preferable that the amide compound in the present embodiment have molecules containing an imide group. Mechanical characteristics of the insulating film after applying and baking the polyamide-imide resin insulating coating material can be improved when the amide compound having a thermally crosslinkable reactive group contains an imide group.

One of methods introducing an imide group into the amide compound is to use the carboxylic acid compound (D) containing an imide group, as described above. When the carboxylic acid compound (D) and the diisocyanate component (E) are reacted at a molar ratio of approximately 2:1, the produced amide compound contains two imide groups.

Meanwhile, another method of introducing an imide group is that tetracarboxylic dianhydride is used as a raw material in addition to the carboxylic acid compound (D) and the diisocyanate component (E). The carboxylic acid compound (D), the diisocyanate component (E) and the tetracarboxylic dianhydride are mixed at, e.g., a molar ratio of approximately 2:2:1 and are heated in a solvent at 60 to 140° C., which causes decarboxylation reaction between the carboxylic acid and the isocyanate group and between the anhydride group and the isocyanate group, thereby respectively producing an amide bond and an imide bond.

As the tetracarboxylic dianhydride, it is possible to use pyromellitic dianhydride (PMDA), 3,3′,4,4′-benzophenone-tetracarboxylic dianhydride (BTDA), 3,3′,4,4′-diphenyl sulfone-tetracarboxylic dianhydride (DSDA), 4,4′-oxydiphthalic dianhydride (ODPA), 3,3′,4,4′ biphenyltetracarboxylic dianhydride, 4,4′-(2,2-hexafluoroisopropylidene) bis(phthalic anhydride) (6FDA) and 2,2-bis[4-(3,4-dicarboxyphenoxy)phenyl]propane dianhydride (BPADA), etc. In addition, butanetetracarboxylic dianhydride, 5-(2,5-dioxotetrahydro-3-furanyl)-3-methyl-3-cyclohexene-1,2-dicarboxylic anhydride or alicyclic tetracarboxylic dianhydride produced by hydrogenation of the above-mentioned tetracarboxylic dianhydrides, etc., may be combined where appropriate. In addition, among the above, plural tetracarboxylic dianhydrides may be combined.

In addition, it is preferable that the amide compound of the present embodiment be a compound synthesized using the carboxylic acid compound (D), the diisocyanate component (E) and trimellitic anhydride (TMA) as raw materials. The same backbone as that of polyamide-imide containing amide and imide groups obtained by an isocyanate method can be obtained by reaction of the diisocyanate component (E) with trimellitic anhydride. In addition, it is possible to produce an amide compound having a thermally crosslinkable reactive group by further reaction with the carboxylic acid compound (D) at a terminal.

For example, the carboxylic acid compound (D), the diisocyanate component (E) and the trimellitic anhydride are mixed at a molar ratio of approximately 2:5:4 and are heated in a solvent at 60 to 140° C. to cause decarboxylation reaction, and an amide compound having amide and imide groups is thereby produced. The mixture ratio can be adjusted according to a balance of the contained amounts of the imide group and the amide group, adhesion between an insulation film formed of the polyamide-imide resin insulating coating material and a conductor, mechanical characteristics and solubility of an amide compound in a solvent.

When the amount of the diisocyanate component (E) or the trimellitic anhydride is more than that of the carboxylic acid compound (D), the characteristics of the polyamide-imide resin are exhibited and a film excellent in adhesion with a conductor and heat resistance is obtained. In this case, however, since solubility of the amide compound in a solvent decreases, the resin is likely to solidify or precipitate when the polyamide-imide resin insulating coating material absorbs water.

Solvents not inhibiting synthesis reaction of the polyamide-imide resin. e.g., N-methyl-2-pyrrolidon (NMP), γ-butyrolactone, N,N-dimethylacetamide (DMAC), N,N-dimethylformamide (DMF), dimethylimidazolidinone (DMI), cyclohexanone and methylcyclohexanone may be combined as a solvent used for the synthesis when synthesizing the amide compound. In addition, a solution may be diluted by these solvents.

In addition, it is preferable that the amide compound in the present embodiment have a number average molecular weight Mn of not more than 5000. It is necessary to improve not only solubility of the polyamic acid but also that of the amide compound in order to suppress solidification and precipitation of the resin when the polyamide-imide resin insulating coating material absorbs water, and in order to achieve this, the amide compound is required to have the number average molecular weight Mn of not more than 5000. When the number average molecular weight Mn is greater than 5000, solubility of the amide compound having a thermally crosslinkable reactive group decreases. More preferably, the number average molecular weight Mn is not more than 3000. Note that, the number average molecular weight Mn of the amide compound can be measured by a gel permeation chromatography (GPC) measuring device (eluent: N-methyl-2-pyrrolidone).

Meanwhile, a weight ratio of the amide compound to the polyamic acid in the present embodiment is preferably from 99:1 to 30:70 (the value of the weight ratio is 3/7 to 99). When the value of the weight ratio of the polyamic acid to the amide compound is greater than 99, characteristics of the polyamide-imide resin insulating coating material derived from the amide compound, such as adhesion, etc., are less likely to be obtained. On the other hand, when the value of the weight ratio is less than 3/7, solidification and precipitation of the resin are likely to occur when the resin absorbs water because of the amide compound having lower solubility. Furthermore, the weight ratio of 95:5 to 80:20 (the value of the weight ratio is 4 to 95) is more preferable.

### EFFECTS OF THE EMBODIMENT

Since the polyamide-imide resin insulating coating material in the present embodiment has the above-mentioned structure, solidification and precipitation of the resin are less likely occur at the time of water absorption even when the numbers of the amide and imide groups per molecular repeat unit are small. Therefore, solidification and precipitation of the resin can be effectively suppressed even in the season of high temperature and high humidity, especially in the summer or the rainy season, etc., and equipments and works for adjusting temperature and humidity are not necessary, hence, an increase in cost is suppressed. That is, the polyamide-imide resin insulating coating material in the present embodiment allows an insulating film excellent in partial discharge resistance to be formed, and is excellent in coating workability and cost performance.

In addition, an insulated wire having an insulating film excellent in partial discharge resistance can be formed at low cost by using the polyamide-imide resin insulating coating material. Such an insulated wire can be used for forming a coil constituting, e.g., electrical equipments such as motor and power generator.

### EXAMPLES

Polyamide-imide resin insulating coating materials were made by methods described in the following Examples 1 to 7 and Comparative Examples 1 to 3, and subsequently, each polyamide-imide resin insulating coating material was evaluated for likelihood of solidification of the resin at the time of water absorption.

### Example 1

Firstly, a flask to which a stirrer, a nitrogen inlet tube, a thermometer, a cooling tube and a moisture determination container are attached was prepared. Then, 37.3 g of 4-aminobenzoic acid and 41.3 g of 1,2,3,6-tetrahydrophthalic anhydride were dissolved, together with 30 g of xylene as an azeotropic solvent, in 300 g of N-methyl-2-pyrrolidon in the flask. Then, the solution was stirred at 180° C. to remove the produced water and the xylene out of the system, thereby obtaining a reaction solution containing a carboxylic acid compound as the carboxylic acid compound (D) in the embodiment.

Next, after the reaction solution was cooled to 60° C., 40.8 g of 4,4′-diphenylmethane diisocyanate as the diisocyanate component (E) in the embodiment was introduced into the flask and was stirred at 130° C. for 1 hour and then at 140° C. for 1.5 hours, thereby synthesizing an amide compound having a reactive end group.

Meanwhile, 502.1 g of 2,2-bis(4-aminophenoxy phenyl)propane as the diamine component (A) of the embodiment, 565.9 g of 2,2-bis[4-(3,4-dicarboxyphenoxy)phenyl]propane dianhydride as the tetracarboxylic dianhydride (B) of the embodiment and 26.7 g of maleic anhydride as the cross-linking agent (C) of the embodiment were added to 2778 g N-methyl-2-pyrrolidon and were stirred in another flask, thereby synthesizing an polyamic acid having a reactive end group.

After that, the reaction solution of the polyamic acid and that of the amide compound were mixed, thereby obtaining a polyamide-imide resin insulating coating material.

### Example 2

Firstly, 33.6 g of 4-aminobenzoic acid and 37.2 g of 1,2,3,6-tetrahydrophthalic anhydride were dissolved, together with 30 g of xylene as an azeotropic solvent, in 300 g of N-methyl-2-pyrrolidon in a flask. Then, the solution was stirred at 180° C. to remove the produced water and the xylene out of the system, thereby obtaining a reaction solution containing a carboxylic acid compound as the carboxylic acid compound (D) in the embodiment.

Next, after the reaction solution was cooled to 60° C., 128.6 g of 4,4′-diphenylmethane diisocyanate as the diisocyanate component (E) in the embodiment, 70.5 g of trimellitic anhydride as tricarboxylic acid anhydride and 327.2 g of N-methyl-2-pyrrolidon were introduced into the flask and were stirred at 130° C. for 1 hour and then at 140° C. for 1.5 hours, thereby synthesizing an amide compound having a reactive end group.

Meanwhile, 451.9 g of 2,2-bis(4-aminophenoxy phenyl)propane as the diamine component (A) of the embodiment, 509.3 g of 2,2-bis[4-(3,4-dicarboxyphenoxy) phenyl]propane dianhydride as the tetracarboxylic dianhydride (B) of the embodiment and 24 g of maleic anhydride as the cross-linking agent (C) of the embodiment were added to 2533 g of N-methyl-2-pyrrolidon and were stirred in another flask, thereby synthesizing an polyamic acid having a reactive end group.

After that, the reaction solution of the polyamic acid and that of the amide compound were mixed, thereby obtaining a polyamide-imide resin insulating coating material.

### Example 3

Firstly, 33.6 g of 4-aminobenzoic acid and 37.2 g of 1,2,3,6-tetrahydrophthalic anhydride were dissolved, together with 20 g of xylene as an azeotropic solvent, in 200 g of N-methyl-2-pyrrolidon in a flask. Then, the solution was stirred at 180° C. to remove the produced water and the xylene out of the system, thereby obtaining a reaction solution containing a carboxylic acid compound as the carboxylic acid compound (D) in the embodiment.

Next, after the reaction solution was cooled to 60° C., 189.9 g of 4,4′-diphenylmethane diisocyanate as the diisocyanate component (E) in the embodiment, 117.6 g of trimellitic anhydride as tricarboxylic acid anhydride and 600 g of N-methyl-2-pyrrolidon were introduced into the flask and were stirred at 130° C. for 1 hour and then at 140° C. for 1.5 hours, thereby synthesizing an amide compound having a reactive end group.

Meanwhile, 451.9 g of 2,2-bis(4-aminophenoxy phenyl)propane as the diamine component (A) of the embodiment, 509.3 g of 2,2-bis[4-(3,4-dicarboxyphenoxy) phenyl]propane dianhydride as the tetracarboxylic dianhydride (B) of the embodiment and 24.0 g of maleic anhydride as the cross-linking agent (C) of the embodiment were added to 2639 g of N-methyl-2-pyrrolidon and were stirred in another flask, thereby synthesizing an polyamic acid having a reactive end group.

After that, the reaction solution of the polyamic acid and that of the amide compound were mixed, thereby obtaining a polyamide-imide resin insulating coating material.

### Example 4

Firstly, 23.8 g of 4-aminostyrene and 38.4 g of trimellitic anhydride as tricarboxylic acid anhydride were dissolved, together with 30 g of xylene as an azeotropic solvent, in 300 g of N-methyl-2-pyrrolidon in a flask. Then, the solution was stirred at 180° C. to remove the produced water and the xylene out of the system, thereby obtaining a reaction solution containing a carboxylic acid compound as the carboxylic acid compound (D) in the embodiment.

Next, after the reaction solution was cooled to 60° C., 150.1 g of 4,4′-diphenylmethane diisocyanate as the diisocyanate component (E) in the embodiment, 96.1 g of trimellitic anhydride and 300 g of N-methyl-2-pyrrolidon were introduced into the flask and were stirred at 130° C. for 1 hour and then at 140° C. for 1.5 hours, thereby synthesizing an amide compound having a reactive end group.

Meanwhile, 369.2 g of 2,2-bis(4-aminophenoxy phenyl)propane as the diamine component (A) of the embodiment, 416.1 g of 2,2-bis[4-(3,4-dicarboxyphenoxy)phenyl]propane dianhydride as the tetracarboxylic dianhydride (B) of the embodiment and 19.6 g of maleic anhydride as the cross-linking agent (C) of the embodiment were added to 2231 g of N-methyl-2-pyrrolidon and were stirred in another flask, thereby synthesizing an polyamic acid having a reactive end group.

After that, the reaction solution of the polyamic acid and that of the amide compound were mixed, thereby obtaining a polyamide-imide resin insulating coating material.

### Example 5

Firstly, 16.7 g of 4-aminostyrene and 26.9 g of trimellitic anhydride as tricarboxylic acid anhydride were dissolved, together with 30 g of xylene as an azeotropic solvent, in 300 g of N-methyl-2-pyrrolidon in a flask. Then, the solution was stirred at 180° C. to remove the produced water and the xylene out of the system, thereby obtaining a reaction solution containing a carboxylic acid compound as the carboxylic acid compound (D) in the embodiment.

Next, after the reaction solution was cooled to 60° C., 175.2 g of 4,4′-diphenylmethane diisocyanate as the diisocyanate component (E) in the embodiment, 121 g of trimellitic anhydride and 300 g of N-methyl-2-pyrrolidon were introduced into the flask and were stirred at 130° C. for 1 hour and then at 140° C. for 1.5 hours, thereby synthesizing an amide compound having a reactive end group.

Meanwhile, 258.4 g of 2,2-bis(4-aminophenoxy phenyl)propane as the diamine component (A) of the embodiment, 291.3 g of 2,2-bis[4-(3,4-dicarboxyphenoxy)phenyl]propane dianhydride as the tetracarboxylic dianhydride (B) of the embodiment and 13.7 g of maleic anhydride as the cross-linking agent (C) of the embodiment were added to 1700 g of N-methyl-2-pyrrolidon and were stirred in another flask, thereby synthesizing an polyamic acid having a reactive end group.

After that, the reaction solution of the polyamic acid and that of the amide compound were mixed, thereby obtaining a polyamide-imide resin insulating coating material.

### Example 6

Firstly, 119.2 g of 4-aminostyrene and 192.1 g of trimellitic anhydride as tricarboxylic acid anhydride were dissolved, together with 50 g of xylene as an azeotropic solvent, in 500 g of N-methyl-2-pyrrolidon in a flask. Then, the solution was stirred at 180° C. to remove the produced water and the xylene out of the system, thereby obtaining a reaction solution containing a carboxylic acid compound as the carboxylic acid compound (D) in the embodiment.

Next, after the reaction solution was cooled to 60° C., 373.4 g of 4,4′-diphenylmethane diisocyanate as the diisocyanate component (E) in the embodiment, 192.1 g of trimellitic anhydride and 600 g of N-methyl-2-pyrrolidon were introduced into the flask and were stirred at 130° C. for 1 hour and then at 140° C. for 1.5 hours, thereby synthesizing an amide compound having a reactive end group.

Meanwhile, 184.6 g of 2,2-bis(4-aminophenoxy phenyl)propane as the diamine component (A) of the embodiment, 208.1 g of 2,2-bis[4-(3,4-dicarboxyphenoxy) phenyl]propane dianhydride as the tetracarboxylic dianhydride (B) of the embodiment and 9.8 g of maleic anhydride as the cross-linking agent (C) of the embodiment were added to 2035 g of N-methyl-2-pyrrolidon and were stirred in another flask, thereby synthesizing an polyamic acid having a reactive end group.

After that, the reaction solution of the polyamic acid and that of the amide compound were mixed, thereby obtaining a polyamide-imide resin insulating coating material.

### Example 7

Firstly, 23.8 g (0.20 mol) of 4-aminostyrene and 38.4 g (0.20 mol) of trimellitic anhydride as tricarboxylic acid anhydride were dissolved, together with 30 g of xylene as an azeotropic solvent, in 500 g of N-methyl-2-pyrrolidon in a flask. Then, the solution was stirred at 180° C. to remove the produced water and the xylene out of the system, thereby obtaining a reaction solution containing a carboxylic acid compound as the carboxylic acid compound (D) in the embodiment.

Next, after the reaction solution was cooled to 60° C., 350.4 g (1.4 mol) of 4,4′-diphenylmethane diisocyanate as the diisocyanate component (E) in the embodiment, 249.7 g (1.3 mol) of trimellitic anhydride and 600 g of N-methyl-2-pyrrolidon were introduced into the flask and were stirred at 130° C. for 1 hour and then at 140° C. for 1.5 hours, thereby synthesizing an amide compound having a reactive end group.

Meanwhile, 184.6 g (0.45 mol) of 2,2-bis(4-aminophenoxy phenyl)propane as the diamine component (A) of the embodiment, 208.0 g (0.40 mol) of 2,2-bis[4-(3,4-dicarboxyphenoxy)phenyl]propane dianhydride as the tetracarboxylic dianhydride (B) of the embodiment and 9.8 g (0.1 mol) of maleic anhydride as the cross-linking agent (C) of the embodiment were added to 1924 g of N-methyl-2-pyrrolidon and were stirred in another flask, thereby synthesizing an polyamic acid having a reactive end group.

After that, the reaction solution of the polyamic acid and that of the amide compound were mixed, thereby obtaining a polyamide-imide resin insulating coating material.

### Comparative Example 1

Firstly, 192.1 g (1.0 mol) of trimellitic anhydride as tricarboxylic acid anhydride, 250.0 g (1.0 mol) of 4,4′-diphenylmethane diisocyanate as the diisocyanate component (E) and 1062 g of N-methyl-2-pyrrolidon as a solvent were introduced into a flask and synthesis was carried out at 140° C. One hour later, benzyl alcohol containing about 2% of acid component was added thereto. After stirring for 30 minutes, a polyamide-imide resin insulating coating material was obtained.

In Comparative Example 1, the diamine component (A), the tetracarboxylic dianhydride (B) and the cross-linking agent (C) of the embodiment are not used and the polyamic acid is not contained in the polyamide-imide resin insulating coating material. In addition, a compound having a thermally crosslinkable reactive group which is a raw material of the carboxylic acid compound (D) in the embodiment is not used.

### Comparative Example 2

Firstly, 215.4 g (0.53 mol) of 2,2-bis(4-aminophenoxy phenyl)propane as the diamine component (A), 182.5 g (0.95 mol) of trimellitic anhydride as tricarboxylic acid anhydride, 15.6 g (0.05 mol) of ODPA as the tetracarboxylic dianhydride (B) and 1117 g of N-methyl-2-pyrrolidon as a solvent were introduced into a flask and synthesis was carried out at 180° C. while removing water out of the system.

Then, after the reaction solution was cooled to 60° C. while maintaining the nitrogen atmosphere, 120.1 g (0.48 mol) of 4,4′-diphenylmethane diisocyanate as the diisocyanate component (E) was introduced into the flask and synthesis was carried out at 140° C. One hour later, benzyl alcohol containing about 2% of acid component and 300 g of N-methyl-2-pyrrolidon were added thereto. After stirring for 30 minutes, a polyamide-imide resin insulating coating material was obtained.

In Comparative Example 2, the cross-linking agent (C) of the embodiment is not used and the polyamic acid does not contain a thermally crosslinkable reactive group. In addition, a compound having a thermally crosslinkable reactive group which is a raw material of the carboxylic acid compound (D) in the embodiment is not used.

### Comparative Example 3

Firstly, 291.1 g (0.71 mol) of 2,2-bis(4-aminophenoxy phenyl)propane as the diamine component (A), 111.4 g (0.58 mol) of trimellitic anhydride as tricarboxylic acid anhydride, 150.4 g (0.42 mol) of 3,3′,4,4′-diphenyl sulfone-tetracarboxylic dianhydride as the tetracarboxylic dianhydride (B) and 1124 g of N-methyl-2-pyrrolidon as a solvent were introduced into a flask and synthesis was carried out at 180° C. while removing water out of the system.

Then, after the reaction solution was cooled to 60° C. while maintaining the nitrogen atmosphere, 72.5 g (0.29 mol) of 4,4′-diphenylmethane diisocyanate as the diisocyanate component (E) was introduced into the flask and synthesis was carried out at 140° C. One hour later, benzyl alcohol containing about 2% of acid component and 600 g of N-methyl-2-pyrrolidon were added thereto. After stirring for 30 minutes, a polyamide-imide resin insulating coating material was obtained.

In Comparative Example 3, the cross-linking agent (C) of the embodiment is not used and the polyamic acid does not contain a thermally crosslinkable reactive group. In addition, a compound having a thermally crosslinkable reactive group which is a raw material of the carboxylic acid compound (D) in the embodiment is not used.

Evaluation of Solidification Characteristics

Each of the polyamide-imide resin insulating coating materials made by the above-mentioned methods described in Examples 1 to 7 and Comparative Examples 1 to 3 was placed on an aluminum pan and was stored in a constant temperature and humidity chamber at 30° C. and 50% RH for 30 minutes. After that, the degree of solidification in each polyamide-imide resin insulating coating material was visually observed and evaluated.

Tables 1 and 2 respectively show evaluation results of the coating materials in Examples 1 to 7 and those in Comparative Examples 1 to 3. The symbol “⊚” in the section of “solidification test” in Tables 1 and 2 indicates the case where the coating material is transparent, the symbol “◯” indicates the case where the coating material is slightly solidified but it does not affect coating workability, and the symbol “X” indicates the case where the coating material is solidified and turns into white color.

TABLE 1

| | Example 1 | Example 2 | Example 3 | Example 4 | Example 5 | Example 6 | Example 7 |
|---|---|---|---|---|---|---|---|
| Number average molecular weight Mn | 705 | 1994 | 2878 | 2961 | 4647 | 1457 | 5355 |
| of Amid compound | | | | | | | |
| Weight ratio | 8/92 | 20/80 | 26/74 | 27/73 | 33/67 | 64/36 | 36/64 |
| Polyamic acid/Amid compound | | | | | | | |
| Non-volatile component (wt %) | 28 | 28 | 28 | 28 | 28 | 28 | 25 |
| Solidification test | ⊚ | ⊚ | ⊚ | ⊚ | ⊚ | ⊚ | ◯ |

TABLE 2

| | Comparative | Comparative | Comparative |
|---|---|---|---|
| | Example 1 | Example 2 | Example 3 |
| Number average molecular | — | — | — |
| weight Mn of Amid | | | |
| compound | | | |
| Weight ratio | — | — | — |
| Polyamic acid/Amid | | | |
| compound | | | |
| Non-volatile component | 25 | 25 | 25 |
| (wt %) | | | |
| Solidification test | X | X | X |

Tables 1 and 2 show that solidification of the resin at the time of water absorption is suppressed in the polyamide-imide resin insulating coating materials of Examples 1 to 7 which are examples of the embodiment, and the resin is solidified at the time of water absorption in the polyamide-imide resin insulating coating materials of Comparative Examples 1 to 3.

Although the embodiment and examples of the invention have been described, the invention according to claims is not to be limited to the above-mentioned embodiment and examples. Further, please note that not all combinations of the features described in the embodiment and examples are not necessary to solve the problem of the invention.

What is claimed is:

1. A polyamide-imide resin insulating coating material, comprising:
an polyamic acid having a thermally crosslinkable reactive group; and
an amide compound having a thermally crosslinkable reactive group,
wherein the polyamic acid comprises an acid synthesized using at least a diamine component, a tetracarboxylic dianhydride and a cross-linking agent as raw materials.
wherein the cross-linking agent comprises an amino group or an anhydride group and a thermally crosslinkable reactive group,
wherein the amide compound comprises a compound synthesized using at least a carboxylic acid compound and a diisocyanate component as raw materials, and
wherein the carboxylic acid compound comprises a thermally crosslinkable reactive group that is crosslinkable with the cross-linking agent contained in the polyamic acid.

2. The polyamide-imide resin insulating coating material according to claim 1, wherein the amide compound includes an imide group in a molecule thereof.

3. The polyamide-imide resin insulating coating material according to claim 1, wherein the amide compound comprises a compound synthesized using at least the carboxylic acid compound, the diisocyanate component and a trimellitic anhydride.

4. The polyamide-imide resin insulating coating material according to claim 1, wherein the amide compound has a number average molecular weight Mn of not more than 5000.

5. The polyamide-imide resin insulating coating material according to claim 1, wherein a weight ratio of the amide compound to the polyamic acid is from 99:1 to 30:70.

6. The polyamide-imide resin insulating coating material according to claim 1, wherein the cross-linking agent comprises a compound having an unsaturated double or triple bond as a thermally crosslinkable reactive group.

7. The polyamide-imide resin insulating coating material according to claim 1, wherein the cross-linking agent comprises maleic anhydride.

8. The polyamide-imide resin insulating coating material according to claim 1, wherein the polyamic acid is terminated by an anhydride group.

9. The polyamide-imide resin insulating coating material according to claim 1, wherein the polyamic acid is terminated by an amino group.

10. An insulated wire, comprising:
a conductor, and
an insulating film comprising the polyamide-imide resin insulating coating material according to claim 1 and formed on the conductor or on another film on the conductor.

11. A coil, comprising:
the insulated wire according to claim 10.
